(19) United States
(12) Patent Application Publication
(10) Pub. No.: US 2009/0138713 A1
(43) Pub. Date: May 28, 2009

(54) PROXY USE WITHIN A MESH NETWORK

(76) Inventor: Michel VEILLETTE, Waterloo (CA)

Correspondence Address: King and Spalding LLP (Trilliant);Trilliant Customer Number, 1700 Pennsylvania Avenue, NW, Suite 200, Washington, DC, 20006, US

(21) Appl. No.: 12/275,247

(22) Filed: Nov. 21, 2008

Related U.S. Application Data
(60) Provisional application No. 60/989,957, filed on Nov. 25, 2007.
(60) Provisional application No. 60/989,967, filed on Nov. 25, 2007.
(60) Provisional application No. 60/989,958, filed on Nov. 25, 2007.
(60) Provisional application No. 60/989,964, filed on Nov. 25, 2007.
(60) Provisional application No. 60/989,950, filed on Nov. 25, 2007.
(60) Provisional application No. 60/989,953, filed on Nov. 25, 2007.
(60) Provisional application No. 60/989,968, filed on Nov. 25, 2007.
(60) Provisional application No. 60/989,975, filed on Nov. 25, 2007.
(60) Provisional application No. 60/989,959, filed on Nov. 25, 2007.
(60) Provisional application No. 60/989,961, filed on Nov. 25, 2007.
(60) Provisional application No. 60/989,962, filed on Nov. 25, 2007.
(60) Provisional application No. 60/989,951, filed on Nov. 25, 2007.
(60) Provisional application No. 60/989,955, filed on Nov. 25, 2007.
(60) Provisional application No. 60/989,952, filed on Nov. 25, 2007.
(60) Provisional application No. 60/989,954, filed on Nov. 25, 2007.
(60) Provisional application No. 60/992,312, filed on Dec. 4, 2007.
(60) Provisional application No. 60/992,313, filed on Dec. 4, 2007.
(60) Provisional application No. 60/992,315, filed on Dec. 4, 2007.
(60) Provisional application No. 61/025,279, filed on Jan. 31, 2008.
(60) Provisional application No. 61/025,270, filed on Jan. 31, 2008.
(60) Provisional application No. 61/025,276, filed on Jan. 31, 2008.
(60) Provisional application No. 61/025,289, filed on Jan. 31, 2008.
(60) Provisional application No. 61/025,282, filed on Jan. 31, 2008.
(60) Provisional application No. 61/025,271, filed on Jan. 31, 2008.
(60) Provisional application No. 61/025,287, filed on Jan. 31, 2008.
(60) Provisional application No. 61/025,278, filed on Jan. 31, 2008.
(60) Provisional application No. 61/025,273, filed on Jan. 31, 2008.
(60) Provisional application No. 61/025,277, filed on Jan. 31, 2008.
(60) Provisional application No. 61/094,116, filed on Sep. 4, 2008.

(51) Int. Cl. G06F 15/16; H04L 9/00

(52) U.S. Cl. 713/171; 709/203

(57) ABSTRACT

A method and system facilitate communications between an unassociated device and a server via a mesh network and a wide area network. The method may include receiving transmissions from candidate proxy devices, wherein each candidate proxy device is associated with a mesh network. The method may include selecting a proxy device from the candidate proxy devices. The method may include communicating with a server via the proxy device and the associated mesh network.

### CROSS REFERENCE TO RELATED APPLICATIONS

This application claims the benefit of priority to the following United States provisional patent applications which are incorporated herein by reference in their entirety:
Ser. No. 60/989,957 entitled “Point-to-Point Communication within a Mesh Network”, filed Nov. 25, 2007 (TR0004-PRO);
Ser. No. 60/989,967 entitled “Efficient And Compact Transport Layer And Model For An Advanced Metering Infrastructure (AMI) Network,” filed Nov. 25, 2007 (TR0003-PRO);
Ser. No. 60/989,958 entitled “Creating And Managing A Mesh Network Including Network Association,” filed Nov. 25, 2007 (TR0005-PRO);
Ser. No. 60/989,964 entitled “Route Optimization Within A Mesh Network,” filed Nov. 25, 2007 (TR0007-PRO);
Ser. No. 60/989,950 entitled “Application Layer Device Agnostic Collector Utilizing ANSI C12.22,” filed Nov. 25, 2007 (TR0009-PRO);
Ser. No. 60/989,953 entitled “System And Method For Real Time Event Report Generation Between Nodes And Head End Server In A Meter Reading Network Including From Smart And Dumb Meters,” filed Nov. 25, 2007 (TR0010-PRO);
Ser. No. 60/989,968 entitled “Proxy Use Within A Mesh Network,” filed Nov. 25, 2007 (TR0012-PRO);
Ser. No. 60/989,975 entitled “System and Method for Network (Mesh) Layer And Application Layer Architecture And Processes,” filed Nov. 25, 2007 (TR0014-PRO);
Ser. No. 60/989,959 entitled “Tree Routing Within a Mesh Network,” filed Nov. 25, 2007 (TR0017-PRO);
Ser. No. 60/989,961 entitled “Source Routing Within a Mesh Network,” filed Nov. 25, 2007 (TR0019-PRO);
Ser. No. 60/989,962 entitled “Creating and Managing a Mesh Network,” filed Nov. 25, 2007 (TR0020-PRO);
Ser. No. 60/989,951 entitled “Network Node And Collector Architecture For Communicating Data And Method Of Communications,” filed Nov. 25, 2007 (TR0021-PRO);
Ser. No. 60/989,955 entitled “System And Method For Recovering From Head End Data Loss And Data Collector Failure In An Automated Meter Reading Infrastructure,” filed Nov. 25, 2007 (TR0022-PRO);
Ser. No. 60/989,952 entitled “System And Method For Assigning Checkpoints To A Plurality Of Network Nodes In Communication With A Device Agnostic Data Collector,” filed Nov. 25, 2007 (TR0023-PRO);
Ser. No. 60/989,954 entitled “System And Method For Synchronizing Data In An Automated Meter Reading Infrastructure,” filed Nov. 25, 2007 (TR0024-PRO);
Ser. No. 60/992,312 entitled “Mesh Network Broadcast,” filed Dec. 4, 2007 (TR0027-PRO);
Ser. No. 60/992,313 entitled “Multi Tree Mesh Networks”, filed Dec. 4, 2007 (TR0028-PRO);
Ser. No. 60/992,315 entitled “Mesh Routing Within a Mesh Network,” filed Dec. 4, 2007 (TR0029-PRO);
Ser. No. 61/025,279 entitled “Point-to-Point Communication within a Mesh Network”, filed Jan. 31, 2008 (TR0030-PRO);
Ser. No. 61/025,270 entitled “Application Layer Device Agnostic Collector Utilizing Standardized Utility Metering Protocol Such As ANSI C12.22,” filed Jan. 31, 2008 (TR0031-PRO);
Ser. No. 61/025,276 entitled “System And Method For Real-Time Event Report Generation Between Nodes And Head End Server In A Meter Reading Network Including From Smart And Dumb Meters,” filed Jan. 31, 2008 (TR0032-PRO);
Ser. No. 61/025,289 entitled “Proxy Use Within A Mesh Network,” filed Jan. 31, 2008 (TR0034-PRO);
Ser. No. 61/025,282 entitled “Method And System for Creating And Managing Association And Balancing Of A Mesh Device In A Mesh Network,” filed Jan. 31, 2008 (TR0035-PRO);
Ser. No. 61/025,271 entitled “Method And System for Creating And Managing Association And Balancing Of A Mesh Device In A Mesh Network,” filed Jan. 31, 2008 (TR0037-PRO);
Ser. No. 61/025,287 entitled “System And Method For Operating Mesh Devices In Multi-Tree Overlapping Mesh Networks”, filed Jan. 31, 2008 (TR0038-PRO);
Ser. No. 61/025,278 entitled “System And Method For Recovering From Head End Data Loss And Data Collector Failure In An Automated Meter Reading Infrastructure,” filed Jan. 31, 2008 (TR0039-PRO);
Ser. No. 61/025,273 entitled “System And Method For Assigning Checkpoints to A Plurality Of Network Nodes In Communication With A Device-Agnostic Data Collector,” filed Jan. 31, 2008 (TR0040-PRO);
Ser. No. 61/025,277 entitled “System And Method For Synchronizing Data In An Automated Meter Reading Infrastructure,” filed Jan. 31, 2008 (TR0041-PRO);
Ser. No. 61/094,116 entitled “Message Formats and Processes for Communication Across a Mesh Network,” filed Sep. 4, 2008 (TR0049-PRO).

This application hereby references and incorporates by reference each of the following United States patent applications filed contemporaneously herewith:
serial number ______ entitled “Point-to-Point Communication within a Mesh Network”, filed Nov. 21, 2008 (TR0004-US);
serial number ______ entitled “Efficient And Compact Transport Layer And Model For An Advanced Metering Infrastructure (AMI) Network,” filed Nov. 21, 2008 (TR0003-US);
serial number ______ entitled “Communication and Message Route Optimization and Messaging in a Mesh Network,” filed Nov. 21, 2008 (TR0007-US);
serial number ______ entitled “Collector Device and System Utilizing Standardized Utility Metering Protocol,” filed Nov. 21, 2008 (TR0009-US);
serial number ______ entitled “Method and System for Creating and Managing Association and Balancing of a Mesh Device in a Mesh Network,” filed Nov. 21, 2008 (TR0020-US); and
serial number ______ entitled “System And Method For Operating Mesh Devices In Multi-Tree Overlapping Mesh Networks”, filed Nov. 21, 2008 (TR0038-US).

### FIELD OF THE INVENTION

This invention pertains generally to methods and systems for providing and using a proxy device associated with a mesh network in order to communicate through the mesh network where an unassociated device may be unable to directly associate with a mesh network and server but may be able to communicate with the mesh network and the server via the proxy, and by communicating through the proxy the unassociated device is able to communicate with the server.

### BACKGROUND

A mesh network is a wireless network configured to route data between mesh device nodes within the network. It allows for continuous connections and reconfigurations around broken or blocked paths by retransmitting messages from node to node until a destination is reached. Mesh networks differ from other networks in that nodes can all connect to each other via multiple hops. Thus, mesh networks are self-healing: the network remains operational when a node or a connection fails.

Advanced Metering Infrastructure (AMI) or Advanced Metering Management (AMM) are systems that measure, collect and analyze utility usage, from advanced devices such as electricity meters, gas meters, and water meters, through a network on request or a pre-defined schedule. This infrastructure includes hardware, software, communications, customer associated systems and meter data management software. The infrastructure collects and distributes information to customers, suppliers, utility companies and service providers. This enables these businesses to either participate in, or provide, demand response solutions, products and services. Customers may alter energy usage patterns from normal consumption patterns in response to demand pricing. This improves system load and reliability.

### SUMMARY

A method and system provide using a proxy device associated with a mesh network in order to communicate through the mesh network. An unassociated device may be unable to directly associate with a mesh network, but may be able to communicate with the mesh network and the server via the proxy. By communicating through the proxy, the unassociated device is able to communicate with the server. However, the unassociated device is not allowed to participate in the mesh network. Example unassociated devices may be service trucks, mobile devices used by service personnel, transformers and other assets used in the AMI system, uncommissioned mesh devices, and mesh devices in distress (for example, after suffering a memory loss).

In one aspect, there is provided a method, including: receiving transmissions from candidate proxy devices, wherein each candidate proxy device is associated with a mesh network; selecting a proxy device from the candidate proxy devices; and communicating with a server via the proxy device and the associated mesh network.

In another aspect, there is provided a method, including: associating with a mesh network; transmitting a proxy information to an unassociated device; receiving a proxy service request from the unassociated device; and forwarding communications from the unassociated device to a server via the associated mesh network.

In another aspect, there is provided a device, including: a memory storing a device key; a radio, wherein, in operation, the device is configured to: receive transmissions from candidate proxy devices, wherein each candidate proxy device is associated with a mesh network; select a proxy device from the candidate proxy devices; and communicate with a server via the proxy device and the associated mesh network.

In another aspect, there is provided an apparatus, including: a receiver receiving transmissions from candidate proxy devices, wherein each candidate proxy device is associated with a mesh network; a selection logic selecting a proxy device from the candidate proxy devices; and a radio for communicating with a server via the proxy device and the associated mesh network.

In another aspect, there is provided an apparatus, including: association logic for associating with a mesh network; a transmitter for transmitting a proxy information to an unassociated device; a receiver for receiving a proxy service request from the unassociated device; and communications forwarding logic coupled with at least one of the transmitter and receiver for forwarding communications from the unassociated device to a server via the associated mesh network.

In another aspect, there is provided a method of communicating with a mesh network via a selected proxy device, including: associating with a mesh network by the selected proxy device; transmitting a proxy information from the selected proxy device to an unassociated device; receiving transmissions at the unassociated device from candidate proxy devices, including the selected proxy device, wherein each candidate proxy device is associated with a mesh network; selecting the selected proxy device from the candidate proxy devices by the unassociated device; receiving a proxy service request from the unassociated device at the selected proxy device; and communicating with a server via the selected proxy device and the associated mesh network, wherein the selected proxy device forwards communications from the unassociated device to the server via the associated mesh network.

In another aspect, there is provided a system for communicating with a mesh network via a selected proxy device, including: means for associating with a mesh network by the selected proxy device; means for transmitting a proxy information from the selected proxy device to an unassociated device; means for receiving transmissions at the unassociated device from candidate proxy devices, including the selected proxy device, wherein each candidate proxy device is associated with a mesh network; means for selecting the selected proxy device from the candidate proxy devices by the unassociated device; means for receiving a proxy service request from the unassociated device at the selected proxy device; and means for communicating with a server via the selected proxy device and the associated mesh network, wherein the selected proxy device forwards communications from the unassociated device to the server via the associated mesh network.

Other aspects and features will be apparent from the included description, drawings, and accompanying claims.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example system for providing communications in an AMI system.

FIG. 2 illustrates an example mesh device for use within a mesh network.

FIG. 3 illustrates an example network stack for use within a mesh radio.

FIG. 4A illustrates an example procedure for an unassociated device to communicate with a server through a proxy device and a mesh network associated with the proxy device.

FIG. 4B illustrates an example procedure for a proxy device to facilitate communications between a server and an unassociated device.

### DETAILED DESCRIPTION

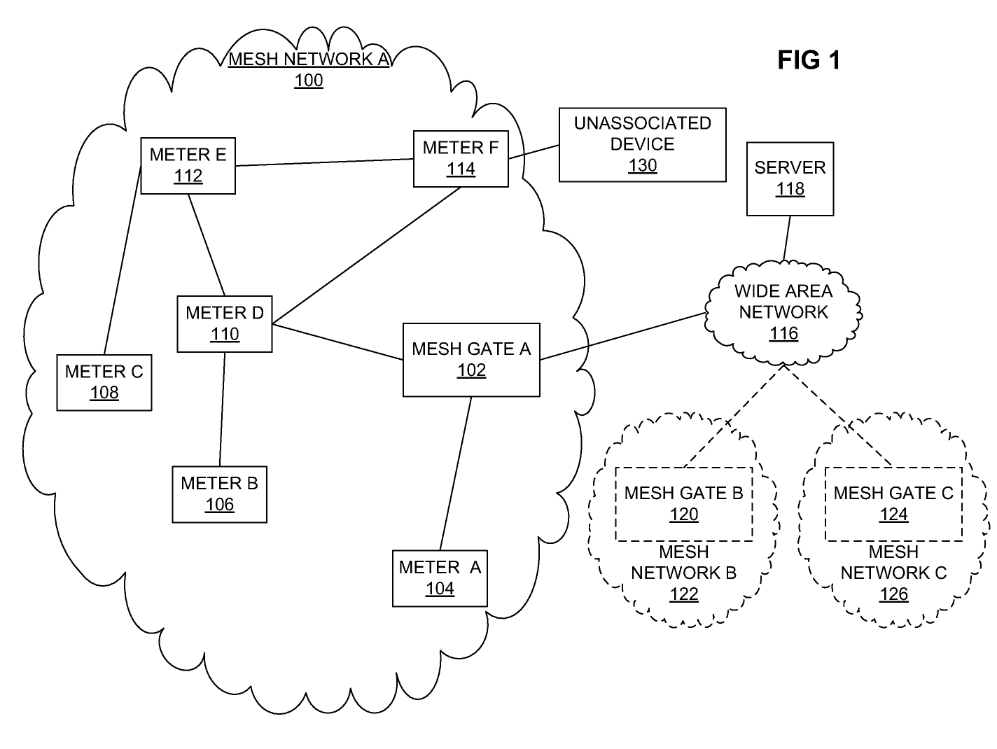

FIG. 1 illustrates an example system for providing communications in an AMI system. A mesh network A 100 may include a mesh gate A 102 and a plurality of meters: meters A 104, B 106, C 108, D 110, E 112, and F 114. A mesh gate may also be referred to as a NAN-WAN gate or an access point. The mesh gate A 102 may communicate with a server 118 over a wide area network (WAN) 116. Optionally, a mesh gate B 120 and a mesh network B 122 may also communicate with the server 118 over the WAN 116.

In one example embodiment, the server 118 is known as a “head end.” The mesh gate may also be known as a collector, a concentrator, or an access point.

Optionally, a mesh gate C 124 and a mesh network C 126 may also communicate with the server 118 over the WAN 116. An unassociated device 130 may seek to communicate with the server 118.

In the example of FIG. 1, the mesh network A 100 may include a plurality of mesh gates and mesh devices, such as meters which cover a geographical area. The meters may include utility sensors and be part of an AMI system and communicate with the mesh gates over the mesh network. For example, the AMI system may monitor utilities usage, such as gas, water, or electricity. Alternative mesh devices include thermostats, user displays, and other components for monitoring utilities. An unassociated device may be added to the system, for example, a newly installed meter or a mobile device to be tracked.

In the example of FIG. 1, the mesh gate A 102 may provide a gateway between the mesh network and a server. The mesh gate A 102 may include a mesh radio to communicate with the mesh network and a WAN communication interface to communicate with a WAN.

In the example of FIG. 1, the mesh gate A 102 may aggregate information from meters within the mesh network and transmit the information to the server. While only one mesh gate is depicted, any number of mesh gates may be deployed within the mesh network, for example, to improve transmission bandwidth to the server and provide redundancy in the mesh network. A typical system will include a plurality of mesh gates within the mesh network. In a non-limiting embodiment for an urban or metropolitan geographical area, there may be between 1 and 100 mesh gates, but this is not a limitation of the invention. In one embodiment, each mesh gate supports approximately 400 meters, depending on system requirements, wireless reception conditions, available bandwidth, and other considerations. It will be appreciated that it is preferable to limit meter usage of bandwidth to allow for future upgrades.

In the example of FIG. 1, the meters A 104, B 106, C 108, D 110, E 112, and F 114 may each be a mesh device associated with the mesh network through direct or indirect communications with the mesh gate. Each meter may forward transmissions from other meters within the mesh network towards the mesh gate. While only six meters are depicted, any number of meters may be deployed to cover any number of utility lines or locations within the mesh network.

In the example of FIG. 1, as depicted, only meters A 104 and D 110 are in direct communications with mesh gate A 102. However, meters B 106, E 112 and F 114 can all reach mesh gate A 102 through meter D 110. Similarly, meter C 108 can reach mesh gate A 102 through meter E 112 and meter D 110.

In the example of FIG. 1, the WAN 116 may be a communication medium capable of transmitting digital information. For example, the WAN 116 may be the Internet, a cellular network, a private network, a phone line configured to carry a dial-up connection, an Ethernet network, or any other network.

In the example of FIG. 1, the server 118 may be a computing device configured to receive information, such as meter readings, from a plurality of mesh networks and meters. The server 118 may also be configured to transmit instructions to the mesh networks, mesh gates, and meters.

In an alternative, any number of servers may be deployed in the AMI system. For example, servers may be distributed by geographical location for shorter communication distances and latency times. Redundant servers may provide backup and failover capabilities in the AMI system.

In the example of FIG. 1, the optional mesh gates B 120 and C 124 may be similar to mesh gate A 102, discussed above. Each mesh gate may be associated with a mesh network, similar to the mesh network A 102. For example, mesh gate B 120 may be associated with mesh network B 122 and mesh gate C 124 may be associated with mesh network C 126. Each mesh network may include a plurality of meters (not depicted).

In the example of FIG. 1, each mesh network may include meters covering a geographical area, such as a premise, a residential building, an apartment building, or a residential block. Alternatively, the mesh network may include a utilities network and be configured to measure utilities flow at each sensor. Each mesh gate communicates with the server over the WAN, and thus the server may receive information from and control a large number of meters or mesh devices. Mesh devices may be located wherever they are needed, without the necessity of providing wired communications with the server.

In the example of FIG. 1, the unassociated device 130 may be a device with a mesh radio configured to communicate with the server via a proxy, the proxy associated with the mesh network. For example, the unassociated device 130 may be a newly installed meter, which needs to authenticate itself with the server before associating with a mesh network.

In an alternative, the unassociated device 130 may be a mobile asset in the AMI system that needs to be tracked. For example, the unassociated device 130 may be a repair vehicle used by service personnel to service mesh devices within the AMI system. The unassociated device 130 may continuously seek out nearby candidate proxy devices and transmit its present location and other information to the server via a proxy device and its associated mesh network.

In the example of FIG. 1, the unassociated device 130 may be loaded with a unique device key at manufacture. Upon power up or responsive to user instruction, the unassociated device may seek nearby candidate proxy devices, for example, meters in a mesh network. In one example, the unassociated device may wait for a neighbor exchange to be transmitted among the meters of the mesh network, from which neighbor information may be collected. The unassociated device may receive and parse the neighbor exchange to determine nearby candidate proxy devices. In an alternative, any secure method may be used to communicate the device key to the unassociated device.

In the example of FIG. 1, the unassociated device 130 may select a nearby meter as a proxy device and send a request to the proxy device for proxy services. The request may include the device key, a request to use the proxy in communications with the mesh network, and any other necessary or helpful information.

In the example of FIG. 1, the proxy device may forward the request to the mesh gate, which then forwards the request to the server. The server may begin a communication with the device through the mesh gate and proxy device. For example, the communication may be encrypted with the device key.

In the example of FIG. 1, the proxy device may be used to commission newly installed meters. Only authorized meters may be allowed to communicate with the server via mesh gates. When a newly-installed meter first powers on, it may not yet be authorized. Thus, the new meter may communicate a device key, a commissioning request, and an authentication key through its proxy.

In the example of FIG. 1, the method may be used in asset tracking. For example, an unassociated device 130 may be mobile and associate with nearby mesh networks to communicate with the server. For example, the unassociated device may be a service truck servicing meters in a neighborhood. Each time the service truck is within radio range of a mesh network, it may select a proxy and transmit its status and location to the server.

In the example of FIG. 1, in operation, an AMI system may facilitate communications between the system components. A mesh network A 100 may include a plurality of meters. An unassociated device 130 may be unassociated with the mesh network A 100 and communicate with a proxy device, such as one of the meters. The unassociated device 130 may select a proxy device from candidate proxy devices within mesh radio range. For example, the unassociated device 130 may select meter F 114. The unassociated device 130 may broadcast a communication with the server 118 via meter F 114. This method may be used in asset tracking or commissioning of newly installed devices.

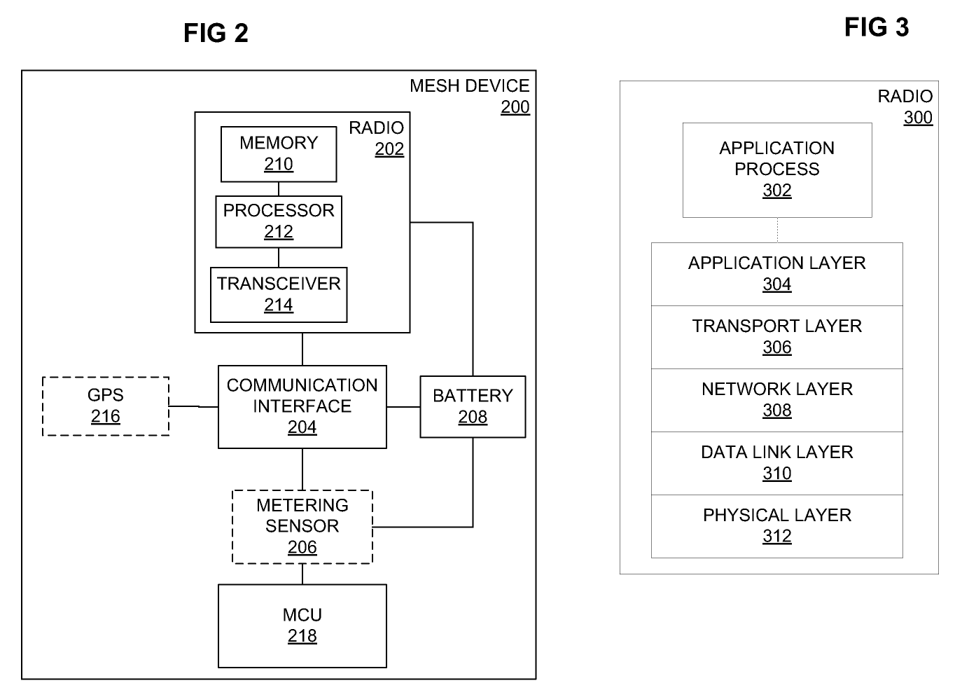

FIG. 2 illustrates an example mesh device for use within a mesh network. A mesh device 200 may include a radio 202, a communication interface 204, a metering sensor 206, a battery 208, a microcontroller unit (MCU) 218, and a GPS receiver 216. The radio 202 may include a memory 210, a processor 212, and a transceiver 214.

In the example of FIG. 2, the mesh device 200 may communicate with a mesh gate and other mesh devices over a mesh network. For example, the mesh device 200 may be a gas, water or electricity meter installed in a residential building or other location to monitor utilities usage. The mesh device 200 may also control access to utilities on server instructions, for example, by reducing or stopping the flow of gas, water or electricity. In an alternative, the mesh device 200 may be a mobile asset that needs to be tracked by the AMI system.

A mesh device can be any device configured to participate as a node within a mesh network. An example mesh device is a mesh repeater, which can be a wired device configured to retransmit received mesh transmissions. This extends a range of a mesh network and provides mesh network functionality to mesh devices that enter sleep cycles.

In the example of FIG. 2, the radio 202 may be a mesh radio configured to communicate with a mesh network. The radio 202 may transmit, receive, and forward messages to the mesh network. Any meter within the mesh network may thus communicate with any other meter or mesh gate by communicating with its neighbor and requesting a message be forwarded. The radio 202 may also communicate with an off-network device not associated with the mesh network.

In the example of FIG. 2, the communication interface 204 may interface between the radio and the sensor. Sensor readings or other data may be converted to radio signals for transmission over the radio. The communication interface 204 may include encryption/decryption functionality or other security measures to protect the transmitted data. The communication interface 204 may also decode instructions received from the server.

In the example of FIG. 2, the optional metering sensor 206 may be a gas, water, or electricity meter sensor, or another sensor. For example, digital flow sensors may be used to measure a quantity of water or gas flowing into a residence or building. Alternatively, the sensor 206 may be an electricity meter configured to measure a quantity of electricity flowing over a power line.

In the example of FIG. 2, the battery 208 may be configured to independently power the meter during a power outage. For example, the battery 208 may be a large capacitor storing electricity to power the meter for at least five minutes after a power outage. Small compact but high capacity capacitors known as super capacitors are known in the art and may advantageously be used. One exemplary super capacitor is the SESSCAP 50f 2.7v 18×30 mm capacitor. Alternative battery technologies may be used, for example, galvanic cells, electrolytic cells, fuel cells, flow cells, and voltaic cells.

In the example of FIG. 2, the memory 210 may store instructions and run-time variables for execution. For example, the memory 210 may include both volatile and non-volatile memory. The memory 210 may also store a history of sensor readings from the metering sensor 206 and an incoming queue of server instructions.

In the example of FIG. 2, the processor 212 may execute instructions, for example, stored in the memory. Instructions stored in memory 210 may be ordinary instructions, for example, provided at the time of meter installation, or special instructions received from the server during run time.

In the example of FIG. 2, the transceiver 214 may transmit and receive wireless signals to a mesh network. The transceiver 214 may be configured to transmit sensor readings and status updates under control of the processor. The transceiver 214 may receive server instructions from a server, which are communicated to the memory and the processor.

In the example of FIG. 2, the optional GPS unit 216 may be configured to receive GPS satellite transmission and calculate a physical location of the GPS unit 216. For example, a service truck may use the GPS unit to calculate a physical location to be transmitted to the server every time the service truck is within range of a mesh device in the AMI system. As another example, a mesh device may use the GPS unit to calculate a physical location to be transmitted to the server along with a request from an unassociated device if the unassociated device does not have a GPS unit.

In the example of FIG. 2A, the MCU 218 can execute firmware or software required by the meter 200. The firmware or software can be installed at manufacture or via a mesh network over the radio 202.

In one embodiment, any number of MCUs can exist in the meter 200. For example, two MCUs can be installed, a first MCU for executing firmware handling communication protocols, and a second MCU for handling applications.

In the example of FIG. 2, each component may be modular and configured for easy removal and replacement. This facilitates component upgrading over a lifetime of the meter as new functionality are developed and deployed in the AMI system.

In the example of FIG. 2, meters may be located in geographically dispersed locations within an AMI system. For example, a meter may be located near a gas line, an electric line, or a water line entering a building or premise to monitor a quantity of gas, electricity, or water flowing through the line. The meter may communicate with other meters and mesh gates through a mesh network. The meter may transmit meter readings and receive instructions via the mesh network.

In the example of FIG. 2, in operation, the mesh device 200 may communicate over a mesh network and directly with an off-network device via the radio 202. The communication interface 204 may interface between the metering sensor 206 and the radio 202. For example, sensor readings may be transmitted to and instructions received from a server.

In an alternative, mesh devices may be similar to meters except the metering sensor is replaced by whatever component is necessary to perform the mesh device's function. For example, a user display may include an output screen. As another example, a thermostat may include a dial for receiving user input and an analog/digital converter to produce an input signal.

It will be appreciated that a mesh gate can share the architecture of a mesh device 200. The radio 202 and the MCU 218 provide the hardware necessary, and the MCU 218 executes any necessary firmware or software.

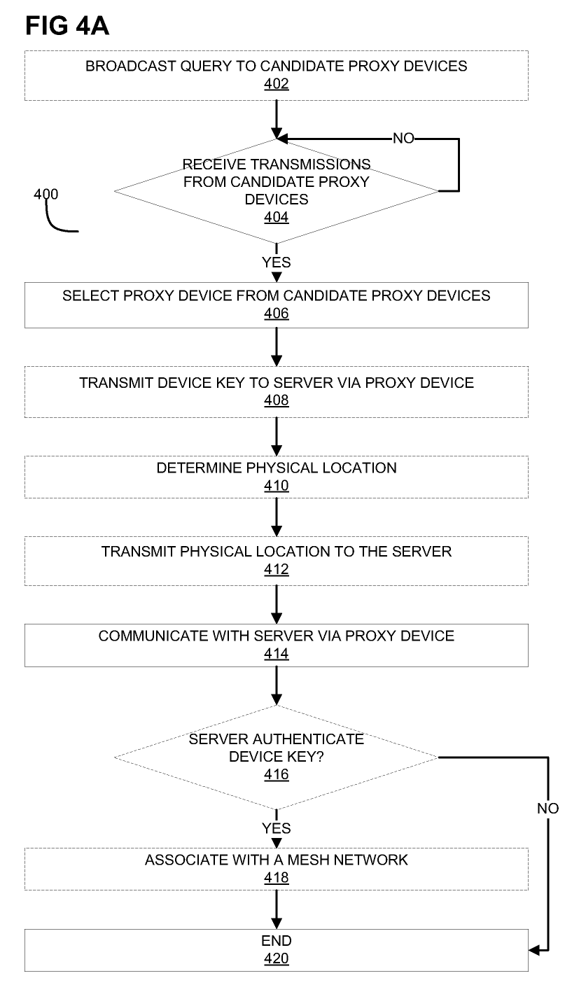

FIG. 3 illustrates an example network stack for use within a mesh radio 300. The application process 302 may communicate with an application layer 304, a transport layer 306, a network layer 308, a data link layer 310 and a physical layer 312.

In the example of FIG. 3, the radio 300 may be a mesh radio installed in a mesh gate, a mesh device or an off-network device. For example, the radio 300 may be a component in a meter, a mesh gate, or any other mesh device configured to participate in a mesh network or communicate with other mesh devices. The radio 300 may be configured to transmit wireless signals over a predetermined or dynamically determined frequency to other radios.

In the example of FIG. 3, the application process 302 may be an executing application that requires information to be communicated over the network stack. For example, the application process 302 may be software supporting an AMI system, such as software executing on an electricity meter or a mesh gate.

In the example of FIG. 3, the application layer 304 interfaces directly with and performs common application services for application processes. Functionality includes semantic conversion between associated application processes. For example, the application layer may be implemented as ANSI C12.12/22.

In the example of FIG. 3, the transport layer 306 responds to service requests from the application layer 304 and issues service requests to the network layer 308. The transport layer 306 delivers data to the appropriate application on the host computers. For example, the transport layer 306 may be implemented as TCP (Transmission Control Protocol), and UDP (User Datagram Protocol).

In the example of FIG. 3, the network layer 308 is responsible for end to end (source to destination) packet delivery. The layer's functionality includes transferring variable length data sequences from a source to a destination via one or more networks while maintaining the quality of service, and error control functions. Data will be transmitted from its source to its destination, even if the transmission path involves multiple hops. For example, the network layer 308 may translate a short address into a network address.

In the example of FIG. 3, the data link layer 310 transfers data between adjacent network nodes in a network, wherein the data is in the form of packets. The layer provides functionality including transferring data between network entities and error correction/detection. For example, the layer may be implemented as IEEE 802.15.4.

In the example of FIG. 3, the physical layer 312 may be the most basic network layer, transmitting bits over a data link connecting network nodes. No packet headers or trailers are included. The bit stream may be grouped into code words or symbols and converted to a physical signal, which is transmitted over a transmission medium, such as radio waves. The physical layer provides an electrical, mechanical, and procedural interface to the transmission medium. For example, the layer may be implemented as IEEE 802.15.4.

In the example of FIG. 3, in operation, the network stack provides different levels of abstraction for programmers within an AMI system. Abstraction reduces a concept to only information which is relevant for a particular purpose. Thus, each level of the network stack may assume the functionality below it on the stack is implemented. This facilitates programming features and functionality for the AMI system. The illustrated network stack may facilitate intra-mesh network communication by utilizing a short address to identify addressees.

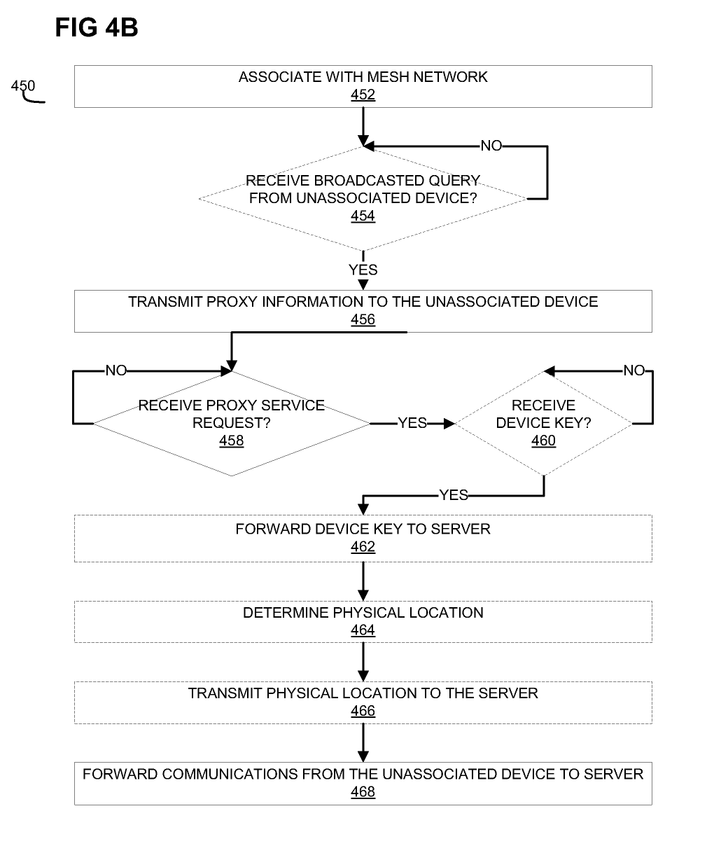

FIG. 4A illustrates an example procedure 400 for an unassociated device to communicate with a server through a proxy device and a mesh network associated with the proxy device. It should be understood that exemplary procedure 400 and the other exemplary procedures described herein may be performed in a different order or certain steps may be performed simultaneously in other embodiments. The procedure may execute on the unassociated device including a mesh radio, such as a newly installed meter or a mobile device. The unassociated device may include a device identifier used to identify the unassociated device to the server for authentication purposes.

In the example of FIG. 4A, in 402, the unassociated device 130 may optionally broadcast a query to nearby candidate proxy devices 114. The broadcasted query may include a request for response from nearby candidate proxy devices. For example, a candidate proxy device may be a mesh device, such as a meter, with additional software to provide proxy functionality. The candidate proxy device may already be associated with a mesh network and mesh gate, and therefore capable of communications with the server.

In the example of FIG. 4A, in 404, the unassociated device 130 may receive transmissions from nearby candidate proxy devices 114. For example, candidate proxy devices may respond to the broadcasted query if proxy capacity exists to service the unassociated device. The candidate proxy device may be configured to only support a predetermined or dynamically determined number of unassociated devices, limited by computing power, memory, and other resources. If the candidate proxy device is already at capacity supporting other unassociated devices, it may not send a transmission.

In an alternative, the transmissions may be a regular neighbor information exchange between mesh devices of a mesh network. Neighbor information exchange may occur in a mesh network regularly to help maintain the mesh network, and the unassociated device may wait to receive the transmissions.

In the example of FIG. 4A, in 404, if transmissions are received from candidate proxy devices, the unassociated device 130 may proceed to 406. If no transmissions are received, the unassociated device may continue waiting. In an alternative, if no transmissions are received, it may be that no candidate proxy devices are within range. Therefore communication with the server is not possible at the time, and the procedure may end.

In the example of FIG. 4A, in 406, the unassociated device 130 may select a proxy device from the candidate proxy devices from which transmissions were received above. The unassociated device may compile a list of all candidate proxy devices from which transmissions were received. From the list of candidate proxy device, a proxy device may be selected. For example, the proxy device may be selected on the basis of a variety of factors, such as distance from the unassociated device, a signal strength and quality, a proxy load, a proxy distance to the mesh gate, a proxy to mesh gate signal strength and quality, a mesh gate load, or other factors. For example, a proxy rating may be calculated through a formula including one or more of the above factors, and the proxy device with the best proxy rating is selected.

In the example of FIG. 4A, in 408, the unassociated device may optionally transmit a device key to a server via the proxy device. For example, the unassociated device may be loaded with a device key at manufacture. In an alternative, the unassociated device may receive a device key via a secure transmission or other method at installation or other time. For example, the device key may be a unique identifier that is linked with the unassociated device, the unique identifier including alpha-numeric characters. In an alternative, the device key may simply be an identifier. The device key may be transmitted to the proxy device, which forwards the device key to the associated mesh gate via the mesh network, which forwards the device key to the server via the WAN.

In one example embodiment, the device key can be set in the unassociated device at time of manufacture. In another example embodiment, the device key can be received during an over-the-air commission process, during which the unassociated device is authenticated to the server and the device key is transmitted to the unassociated device.

In an alternative embodiment, different services can be supported by different functionality. For example, the server can commission the unassociated device with a certificate installed at manufacture, receive an encrypted physical location, or transmit software/information to the unassociated device. The unassociated device can have a pre-installed key to decrypt downloads and encrypt uploads.

In the example of FIG. 4A, in 410, the unassociated device may optionally determine a physical location. For example, the unassociated device may include a global positioning satellite unit 216 configured to calculate a physical location. Alternatively, other methods of determining a physical location, for example, user input and inertial calculation may be used. In an alternative, transmitters with known locations may be set up through a geographical area of the AMI system. If the unassociated device receives one or more signals from such transmitters, it may triangulate its physical position.

In the example of FIG. 4A, in 412, the unassociated device may optionally transmit the physical location to the server via the proxy device. For example, the server may be configured to track the location of the unassociated device. Every time the unassociated device is within radio range of a proxy device, the unassociated device may attempt to transmit its physical location to the server via a proxy device. The physical location may be transmitted to the proxy device as digital information, which forwards the physical location to the associated mesh gate via the mesh network 100, which forwards the physical location to the server via the WAN 116.

In the example of FIG. 4A, in 414, the unassociated device may communicate with the server via the proxy device. Communications to the server may be transmitted to the proxy device, which forwards the communications to the associated mesh gate 102 via the mesh network 100, which forwards the communications to the server via the WAN 116. The path may be used in reverse for any responses or requests sent to the unassociated device from the server.

For example, communications may include a request by the unassociated device to be authenticated so it may associate with a mesh network in the AMI system. For example, communications may include status updates by the unassociated device, including a current physical location. Other information may also be transmitted, such as an operating history of the unassociated device.

In the example of FIG. 4A, in 416, the unassociated device may optionally test whether the server has authenticated the transmitted device key. For example, the server may check the device key is valid and is authorized to access the AMI system. In an alternative embodiment, communications between the server and the unassociated device may be encrypted with the device key. If the device key is authenticated, the unassociated device may proceed to 418. If the device key is not authenticated, the procedure may end. In an alternative embodiment, alternative methods of authenticating the unassociated device may be used in case the device key is not authenticated.

In the example of FIG. 4A, in 418, the unassociated device may optionally associate with a mesh network. If the unassociated device is properly authenticated, it may be authorized to associate with a mesh network within the AMI system. After the unassociated device associated with the mesh network, it may function as a regular mesh device.

In this example, 416 and 418 can be executed in providing over the air provisioning for the unassociated device.

In the example of FIG. 4A, in 420, the unassociated device may end the procedure. If the unassociated device is a mobile asset to be tracked, the procedure may end when the physical location has been transmitted or when the mobile asset moves out of radio range of the proxy device.

In the example of FIG. 4A, in operation, allows the unassociated device to communicate with the server without being authenticated to access any nearby mesh network. Further, the procedure allows the unassociated device to communicate with the server without associating with a nearby mesh network. For example, the procedure may be used to authenticate the unassociated device before allowing it to associate with a mesh network. For example, the procedure may allow the unassociated device to communicate short messages, such as a status update, to the server.

In the example of FIG. 4A, in operation, the unassociated device may select a proxy device from nearby candidate proxy devices. Communications to the server may be channeled through the proxy device. The server may authenticate the unassociated device for associating with a nearby mesh network through a mesh gate. In an alternative, the server may track the unassociated device with a physical position provided by the unassociated device, the proxy device, the mesh gate, or any other device within the AMI system.

FIG. 4B illustrates an example procedure 450 for a proxy device to facilitate communications between a server and an unassociated device. The procedure may execute on the proxy device, the proxy device including a mesh radio. In an alternative, the proxy device may be any mesh device, such as a meter, in the AMI system. For example, the proxy device may be an existing meter or other mesh device in the AMI system with additional proxy functionality.

In the example of FIG. 4B, in 452, the proxy device may associate with a nearby mesh network. The proxy device, such as a meter, may first associate with a mesh network and a mesh gate. After the proxy device is associated with the mesh network, communications are possible between the proxy device and the server. Communications may be transmitted to the mesh gate via the mesh network. Communications may then be forwarded by the mesh gate to the server via the WAN. In one example, the proxy device may select one mesh network from multiple mesh networks that are within radio range.

In the example of FIG. 4B, in 454, the proxy device may optionally test whether a broadcasted query has been received from an unassociated device. For example, an unassociated device may broadcast a query to nearby candidate proxy devices at power-up or other time, in order to determine candidate proxy devices within radio range. In the example of FIG. 4B, in 454, if a broadcasted query is received, the proxy device may proceed to 456. If a broadcasted query is not received, the proxy device may wait.

In an alternative, no broadcasted query is required if the unassociated device simply waits for a regularly scheduled neighbor information exchange within the mesh network among the candidate proxy devices. For example, the mesh devices of a mesh network may regularly transmit neighbor information amongst themselves in order to update and maintain a mesh network map and information.

In one embodiment, the proxy device may request neighbor information from nearby neighbors before processing unassociated device queries.

In the example of FIG. 4B, in 456, the proxy device may transmit a proxy information to the unassociated device. The proxy information may include a distance from the unassociated device, a signal strength and quality, a proxy load, a proxy distance to the mesh gate, a proxy to mesh gate signal strength and quality, a mesh gate load, and other information. For example, the proxy information may be used by the unassociated device to select a proxy device.

In one embodiment, the proxy device may also transmit a list of services provided by the proxy device to the unassociated device.

In the example of FIG. 4B, in 458, the proxy device may test whether a proxy service request was received from the unassociated device. If the proxy device was selected to serve as proxy for the unassociated device, a proxy service request will be received. The proxy service request may include a confirmation of the proxy information and a request to initiate proxy services by the proxy device.

If the proxy service request was received, the proxy device may proceed to 460. If no proxy service request was received, the proxy device may continue waiting. In an alternative, the proxy device may terminate the procedure after a predetermined or dynamically determined time interval, after which it is assumed the unassociated device selected another proxy device.

In the example of FIG. 4B, in 460, the proxy device may optionally test whether a device key was received from the unassociated device. For example, the proxy device may store a device key defined at manufacture or a later time. The device key may be a string of alphanumeric characters that uniquely identify the unassociated device. If a device key is received, the proxy device may proceed to 462. If no device key is received, the proxy device may wait for a device key from the unassociated device before proceeding to 462.

In one embodiment, the device key can be received with the broadcasted query in 454.

In an alternative embodiment, no device key is required from the unassociated device. The server may include other methods to authenticate the unassociated device.

In the example of FIG. 4B, in 462, the proxy device may optionally forward the device key to the server. For example, the device key may be forwarded to the mesh gate via the mesh network, and then to the server via the WAN.

In the example of FIG. 4B, in 464, the proxy device may optionally determine a physical location. The server may track the physical location of the unassociated device as it moves within the AMI system. The physical location may be determined by either the unassociated device, and transmitted to the proxy device for forwarding to the server, or the proxy device, and directly transmitted to the server. For example, the unassociated device or the proxy device may include a global positioning satellite unit used to calculate a physical location. In an alternative embodiment, the unassociated device may receive its physical location via a user input. In an alternative embodiment, the proxy device may be programmed with its physical location at installation. If the proxy device's physical location is known but not the unassociated device's physical location, an approximation may be used to calculate the unassociated device's physical location from the proxy device's physical location.

In the example of FIG. 4B, in 466, the proxy device may optionally transmit the physical location to the server. For example, the physical location may be transmitted to the mesh gate via the mesh network, and from the mesh gate to the server via the WAN.

In the example of FIG. 4B, in 468, the proxy device may forward communications between the unassociated device and the server. Transmissions from the unassociated device may be forwarded to the mesh gate via the mesh network by the proxy device. The transmissions may be further forwarded to the server via the WAN by the mesh gate. Any response from the server may be transmitted along the path in reverse.

In one embodiment, the proxy device can also process responses from the server and forward service responses to the unassociated device if necessary. After 468, the proxy device will provide any message forwarding required to provide the requested service.

In one embodiment, the proxy device can control forwarding requests and responses, for example, by only forwarding one message every 30 seconds. This prevents unauthorized unassociated devices from flooding the proxy device with requests.

In the example of FIG. 4B, in operation, the proxy device may facilitate communications between the unassociated device and the server. The unassociated device may communicate with the server through the proxy device and a mesh network associated with the proxy device. The unassociated device may request proxy service from the proxy device. If granted, the proxy device may forward communications on behalf of the unassociated device to the server. For example, communications may include a device key for authentication purposes or a physical location of the unassociated device. The proxy device may also forward responses from the server to the proxy device.

Although the above embodiments have been discussed with reference to specific example embodiments, it will be evident that the various modification, combinations and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method, comprising:
receiving transmissions from candidate proxy devices, wherein each candidate proxy device is associated with a mesh network;
selecting a proxy device from the candidate proxy devices; and
communicating with a server via the proxy device and the associated mesh network.

2. The method of claim 1, further comprising:
broadcasting a query to nearby candidate proxy devices.

3. The method of claim 1, wherein the selected proxy device is the closest candidate proxy device.

4. The method of claim 1, wherein each transmission includes at least one of: a proxy load, a mesh gate load, a number of hops to a mesh gate, and a path quality indicator.

5. The method of claim 1, further comprising:
transmitting a device key to the server; and
responsive to the server authenticating the device key, associating with a mesh network.

6. The method of claim 5, wherein the device key is loaded at manufacture.

7. The method of claim 5, wherein the device key is loaded at installation.

8. The method of claim 1, further comprising:
determining a physical location; and
transmitting the physical location to the server via the proxy device and the mesh network.

9. The method of claim 8, wherein the physical location is determined, in part, based on a global positioning satellite-calculated position.

10. The method of claim 8, wherein the physical location is determined, in part, based on a proxy device physical location.

11. A method, comprising:
associating with a mesh network;
transmitting a proxy information to an unassociated device;
receiving a proxy service request from the unassociated device; and
forwarding communications from the unassociated device to a server via the associated mesh network.

12. The method of claim 11, further comprising:
transmitting the proxy information responsive to receiving a broadcasted query from the unassociated device.

13. The method of claim 11, wherein the proxy information includes at least one of: a proxy load, a mesh gate load, a number of hops to a mesh gate, and a path quality indicator.

14. The method of claim 11, further comprising:
responsive to receiving a device key from the unassociated device, forwarding the device key to the server.

15. The method of claim 11, further comprising:
determining a physical location; and
transmitting the physical location to the server via the mesh network for use in calculating a physical location of the unassociated device.

16. The method of claim 15, wherein the physical location is determined, in part, based on a global positioning satellite-calculated position.

17. A device, comprising:
a memory storing a device key;
a radio, wherein, in operation, the device is configured to:
receive transmissions from candidate proxy devices, wherein each candidate proxy device is associated with a mesh network;
select a proxy device from the candidate proxy devices; and
communicate with a server via the proxy device and the associated mesh network.

18. The device of claim 17, wherein the memory is a non-volatile memory and the device key is loaded at manufacture of the device.

19. The device of claim 17, wherein the memory is a rewritable memory and the device key loaded at power-up of the device.

20. The device of claim 17, further comprising:
a global positioning satellite unit, the global positioning satellite unit configured to calculate a physical location information of the device.

21. An apparatus, comprising:
a receiver receiving transmissions from candidate proxy devices, wherein each candidate proxy device is associated with a mesh network;
a selection logic selecting a proxy device from the candidate proxy devices; and
a radio for communicating with a server via the proxy device and the associated mesh network.

22. The apparatus of claim 21, wherein:
the radio is configured for broadcasting a query to nearby candidate proxy devices.

23. The apparatus of claim 21, wherein the selected proxy device is the closest candidate proxy device.

24. The apparatus of claim 21, wherein each transmission includes at least one of: a proxy load, a mesh gate load, a number of hops to a mesh gate, and a path quality indicator.

25. The apparatus of claim 21, wherein:
the radio is configured for transmitting a device key to the server; and
further comprising:
device key authentication logic; and
association logic for associating with a mesh network responsive to the server authenticating the device key.

26. The apparatus of claim 25, further including storage loading and storing the device key at manufacture.

27. The apparatus of claim 25, further including storage loading and storing the device key at installation.

28. The apparatus of claim 21, further comprising:
means for determining a physical location; and
wherein the radio is adapted for transmitting the physical location to the server via the proxy device and the mesh network.

29. The apparatus of claim 28, wherein the physical location is determined, in part, based on a global positioning satellite-calculated position.

30. The apparatus of claim 28, wherein the physical location is determined, in part, based on a proxy device physical location.

31. An apparatus, comprising:
association logic for associating with a mesh network;
a transmitter for transmitting a proxy information to an unassociated device;
a receiver for receiving a proxy service request from the unassociated device; and
communications forwarding logic coupled with at least one of the transmitter and receiver for forwarding communications from the unassociated device to a server via the associated mesh network.

32. The apparatus of claim 31, wherein:
the transmitter transmits the proxy information in response to receiving a broadcasted query from the unassociated device.

33. The apparatus of claim 31, wherein the proxy information includes at least one of: a proxy load, a mesh gate load, a number of hops to a mesh gate, and a path quality indicator.

34. The apparatus of claim 31, wherein:
the communications forwarding logic is adapted for forwarding the device key to the server in response to receiving a device key from the unassociated device.

35. The apparatus of claim 31, further comprising:
location identification logic for determining a physical location; and
wherein the communications forwarding logic is adapted for transmitting the physical location to the server via the mesh network for use in calculating a physical location of the unassociated device.

36. The apparatus of claim 35, wherein the location identification logic includes a global positioning system receiver, and the physical location is determined, in part, based on a global positioning satellite-calculated position.

37. A method of communicating with a mesh network via a selected proxy device, comprising:
associating with a mesh network by the selected proxy device;
transmitting a proxy information from the selected proxy device to an unassociated device;
receiving transmissions at the unassociated device from candidate proxy devices, including the selected proxy device, wherein each candidate proxy device is associated with a mesh network;
selecting the selected proxy device from the candidate proxy devices by the unassociated device;
receiving a proxy service request from the unassociated device at the selected proxy device; and
communicating with a server via the selected proxy device and the associated mesh network, wherein the selected proxy device forwards communications from the unassociated device to the server via the associated mesh network.

38. A system for communicating with a mesh network via a selected proxy device, comprising:
means for associating with a mesh network by the selected proxy device;
means for transmitting a proxy information from the selected proxy device to an unassociated device;
means for receiving transmissions at the unassociated device from candidate proxy devices, including the selected proxy device, wherein each candidate proxy device is associated with a mesh network;
means for selecting the selected proxy device from the candidate proxy devices by the unassociated device;
means for receiving a proxy service request from the unassociated device at the selected proxy device; and
means for communicating with a server via the selected proxy device and the associated mesh network, wherein the selected proxy device forwards communications from the unassociated device to the server via the associated mesh network.
